(19) United States
(12) Patent Application Publication
(10) Pub. No.: US 2020/0016955 A1
(43) Pub. Date: Jan. 16, 2020

(54) REAR HVAC CENTER STRUCTURE AND DOOR MECHANISM

(71) Applicant: Calsonic Kansei North America, Inc., Farmington Hills, MI (US)

(72) Inventors: SILVIA DENISSE VAZQUEZ SALAZAR, Farmington Hills, MI (US); Christopher Lynn Dawson, Westland, MI (US)

(21) Appl. No.: 16/034,564

(22) Filed: Jul. 13, 2018

(51) Int. Cl. B60H 1/00; B60H 1/24

(52) U.S. Cl. CPC B60H 1/00864; B60H 1/00564; B60H 1/244

(57) ABSTRACT

An HVAC system for a vehicle includes a first shell, an opposing second shell, and a divider disposed between the first shell and the second shell. The system further includes a first conduit defined between the first shell and a first side of the divider, and a first door disposed in the first conduit and configured to control a volume flow rate in the first conduit. The system further includes a second conduit defined between the second shell and a second side of the divider opposing the first side, and a second door disposed in the second conduit and configured to control a volume flow rate in the second conduit.

### BACKGROUND

The present application relates generally to the field of heating, ventilation, and air conditioning (“HVAC”) systems for vehicles.

In a conventional multi-zone HVAC system, the system includes a single blower which operates at variable rotational speeds. The volume flow rate (i.e., fan speed) of air output from the system and into a passenger compartment of the vehicle varies based on the rotational speed of the blower fan cage. For example, the volume flow rate increases as the blower speed increases and the volume flow rate decreases as the blower speed decreases. In another example, the volume flow rate may be controlled by rotating a door along the stream between open and closed positions to change the cross-sectional area for passing air therethrough. A system may use a single door upstream from the air being split into separate streams. By rotating the door, the volume flow rate of air in each zone is increased or restricted by the same amount. This configuration restricts the ability to separately control the volume flow rate of air supplied to different zones in a vehicle passenger compartment.

It would therefore be advantageous to provide an HVAC system with more than one door that can be separately articulated between open and closed positions in order to provide different volume flow rates of air to different zones in a vehicle passenger compartment.

### SUMMARY

One embodiment relates to an HVAC system for a vehicle, including a first shell, an opposing second shell, and a divider disposed between the first shell and the second shell. The system further includes a first conduit defined between the first shell and a first side of the divider, and a first door disposed in the first conduit and configured to control a volume flow rate in the first conduit. The system further includes a second conduit defined between the second shell and a second side of the divider opposing the first side, and a second door disposed in the second conduit and configured to control a volume flow rate in the second conduit.

Another embodiment relates to an HVAC system for a vehicle, including a shell defining an end surface and a shell edge opposing the end surface, a divider disposed against the shell edge, and a conduit defined between the shell and a first side of the divider. The system further includes a bearing structure having a divider boss extending perpendicular to and away from the first side of the divider and defining a boss end opposing the first side of the divider, and a bore extending from the boss end to the first side of the divider, the bore defining a bore diameter. The system further includes a door disposed in the conduit and configured to control a volume flow rate in the conduit, the door having a hub defining a first door boss and an opposing second door boss that is substantially the same as the first door boss. The bore of the divider boss is configured to receive either of the first door boss or the second door boss.

Another embodiment relates to a method of operating an HVAC system, including providing a blower and separating air output from the blower into first and second conduits downstream from the blower. The method further includes orienting a first door in the first conduit in a first position between an open position and a closed position. The method further includes orienting a second door in the second conduit in a second position between an open position and a closed position, the second position different from the first position. The first conduit is configured to output air at a first volume flow rate and the second conduit is configured to output air at a second volume flow rate different from the first volume flow rate.

### BRIEF DESCRIPTION OF THE DRAWINGS

FIG. 1 is an exploded view of an HVAC system, according to an exemplary embodiment.

FIG. 2 is a partially-assembled view of the HVAC system of FIG. 1.

FIG. 3 is a fully-assembled view of the HVAC system of FIG. 1.

FIG. 4 is a close-up view of a portion of a divider and a door, according to an exemplary embodiment.

FIG. 5 is a cross sectional view of the divider taken across line 5-5 of FIG. 3.

FIG. 6 is a partially-assembled view of the divider and the door of FIG. 4.

### DETAILED DESCRIPTION

Referring to the FIGURES generally, an HVAC system for a vehicle is shown according to various exemplary embodiments. It should be noted that the HVAC system as shown is configured as an air conditioner without a heater, but that the term “HVAC system” is being used to refer generally to systems which deliver air in a vehicle and are configured to control the temperature of the air. Further it should be understood that the HVAC system may be configured as a heater without an evaporator or with both a heater and an evaporator according to various exemplary embodiments.

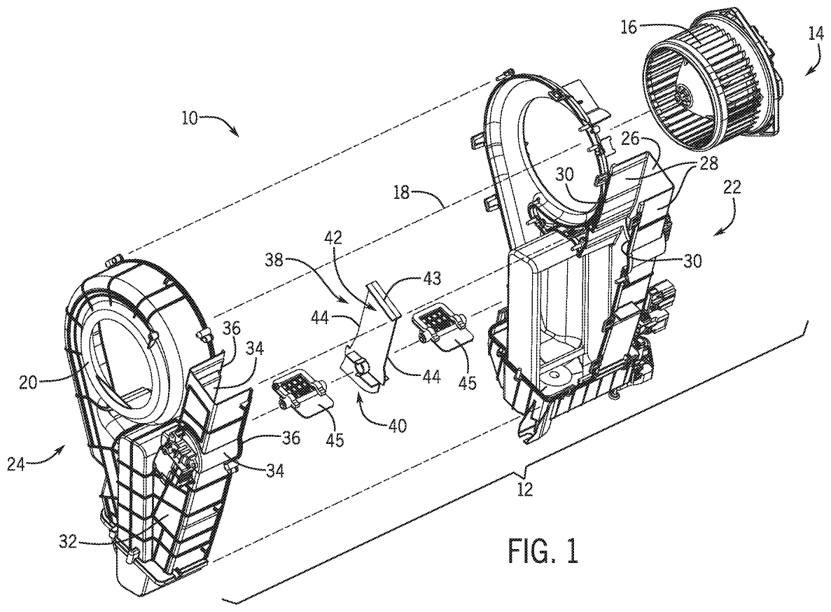

Referring now to FIG. 1, an exploded view of an HVAC system 10 (hereinafter the “system”) is shown according to an exemplary embodiment. The system 10 defines a housing (i.e., case, shell, body, etc.) assembly 12 and a blower 14 disposed within the housing assembly 12. The blower 14 includes an electric motor coupled to a fan cage 16 having a plurality of blades arranged in a cylindrical orientation and configured to rotate about a blower axis 18. The housing assembly 12 is formed from at least two components, including a first (i.e., lower, rear, etc.) shell 22 and a second (i.e., upper, forward, etc.) shell 24 disposed on and engaging the first shell 22. According to an exemplary embodiment, corresponding edges of the first shell 22 and the second shell 24 may define substantially the same outer profile at an edge where they meet, such that the edges are configured to align and/or mate with each other. A blower inlet 20 is defined in the second shell 24 and is configured to correspond to (e.g., be substantially aligned with) the fan cage 16, such that the blower inlet 20 defines a substantially circular profile annularly formed about the blower axis 18.

When the system 10 is in operation, the blower 14 causes the fan cage 16 to rotate within the housing assembly 12, about the blower axis 18. Blades in the fan cage 16 draw air that is outside of the housing assembly 12 through the blower inlet 20 and into an upstream end of the housing assembly 12 for cooling and/or heating. The volume flow rate of air passing through the system 10 may be controlled, at least in part, by adjusting the rotational speed of the blower 14. For example, as the blower 14 increases in rotational speed, the fan cage 16 draws more air into the housing assembly 12, and as the blower 14 decreases in rotational speed, the fan cage 16 draws less air into the housing assembly 12.

As shown in FIG. 1, the first shell 22 defines a first end surface 26 and a first shell wall 28 extending substantially perpendicular to and away from an outer periphery of the first end surface 26. The first shell wall 28 defines a first shell edge 30 opposing the first end surface 26. The second shell 24 defines a second end surface 32 and a second shell wall 34 extending substantially perpendicular to and away from an outer periphery of the second end surface 32. The second shell wall 34 defines a second shell edge 36 opposing the second end surface 32 and defines a complementary profile to the first shell edge 30, such that the second shell edge 36 is configured to be aligned with and engage the first shell edge 30 when the second shell 24 is disposed on the first shell 22. In this configuration, an interior portion of the housing assembly 12 is enclosed within the first and second shells 22, 24.

Referring still to FIG. 1, the system 10 is shown as a multi-zone HVAC system (e.g., with two zones) configured to output separate streams of air to different portions (i.e., zones) of a vehicle passenger compartment. The streams may be configured to provide air to corresponding zones at different temperatures and/or different volume flow rates. The housing assembly 12 includes a divider 38 configured to be disposed between the first shell 22 and the second shell 24 to fluidly separate a portion of the first shell 22 from a portion of the second shell 24. The divider 38 defines a first (i.e., upstream) end 40 and an opposing second (i.e., downstream, outlet, etc.) end 42 defining a divider outlet edge 43. The divider 38 further defines opposing side edges 44 extending between the first and second ends 40, 42 and configured to engage the first shell wall 28 and the second shell wall 34 for securing the divider 38 in place between the first shell 22 and the second shell 24. Separate doors 45 (i.e., first and second doors) are configured to be disposed between the first end surface 26 and the divider 38 and between the second end surface 32 and the divider 38, as will be described in further detail below.

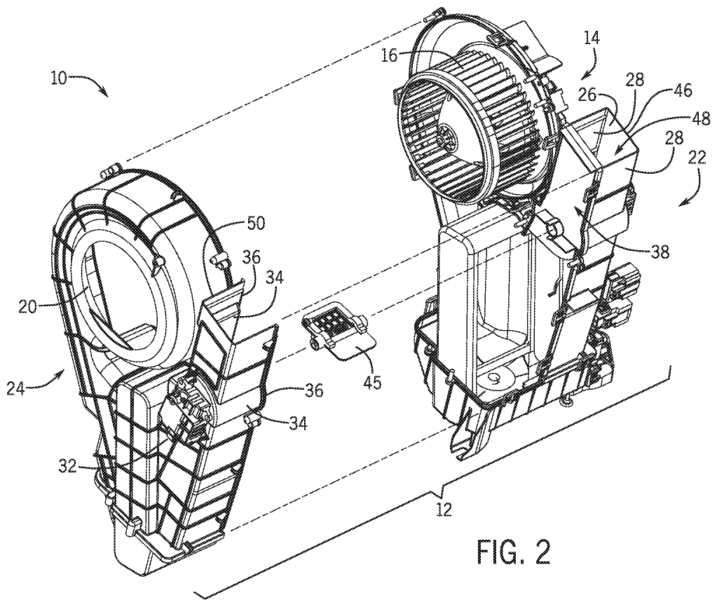

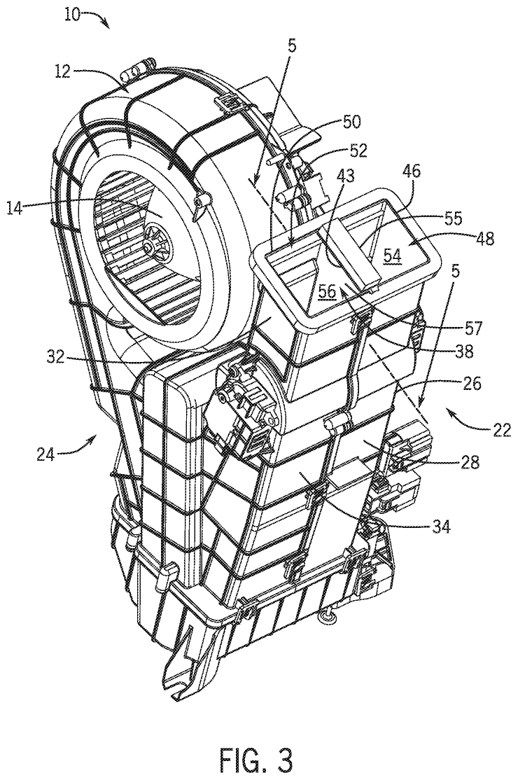

Referring now to FIG. 2, the system 10 is shown with the divider 38 installed on the first shell 22. The first shell 22 includes a first outlet edge 46 defining a substantially “U” shape at a downstream end of the first shell 22. As shown in FIG. 2, the divider outlet edge 43 extends to (e.g., proximate) a downstream end of the first and second shells 22, 24. In this configuration, a first outlet 48 is defined by the first outlet edge 46 and the divider outlet edge 43. The first outlet 48 is configured to be coupled to a first duct (not shown) and output a first stream of air from the system 10, through the first duct to a first zone in the vehicle. The second shell 24 includes a second outlet edge 50 defining a substantially “U” shape at a downstream end of the second shell 24. Referring now to FIG. 3, the system 10 is shown with the second shell 24 installed on the first shell 22 and the divider 38. A second outlet 52 is defined by the second outlet edge 50 and the divider outlet edge 43. The second outlet 52 is configured to be coupled to a second duct (not shown) and output a second stream of air from the system 10, through the second duct separate from the first duct, to a second zone in the vehicle.

A first conduit 54 is defined between the first shell 22 and a first side 55 of the divider 38 and extends from proximate the first end 40 of the divider 38 to the first outlet 48. A second conduit 56 is defined between the second shell 24 and a second side 57 of the divider 38 and extends from proximate the first end 40 of the divider 38 to the second outlet 52. In this configuration, air output from the blower 14 into the housing assembly 12 is separated into separate first and second streams at the first end 40 of the divider 38. The first stream passes through the first conduit 54 and the second stream passes through the second conduit 56 and remains fluidly separate from the first stream downstream from the first end 40 of the divider 38.

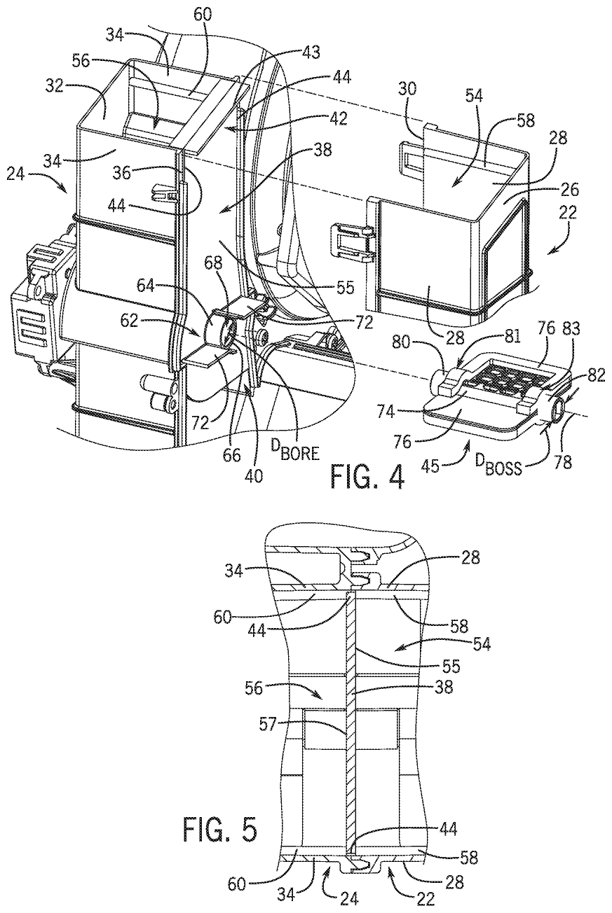

Referring now to FIG. 4, a cutaway view of the first conduit 54 is shown according to an exemplary embodiment. It should be noted that while FIG. 4 refers to the first conduit 54, including the interaction of the first side 55 of the divider 38 and the first shell 22, the second conduit 56 may be similarly configured to the first conduit 54. For example, the second side 57 of the divider 38 engages the second shell 24 in substantially the same way. As shown in FIGS. 4 and 5, a first plurality of flanges 58 extend from the first shell wall 28 inward into the first conduit 54. The first plurality of flanges 58 are disposed offset from but proximate the first shell edge 30. A corresponding second plurality of flanges 60 extend from the second shell wall 34 inward into the second conduit 54. The second plurality of flanges 60 are disposed offset from but proximate the second shell edge 36 and spaced apart from the first plurality of flanges 58 when the second shell 24 is disposed on the first shell 22. The first plurality of flanges 58 are then configured to engage the first side 55 of the divider 38 and the second plurality of flanges 60 are configured to engage the second side 57 of the divider 38 to retain (i.e., secure, constrain, etc.) the divider 38 in place and prevent the divider 38 from moving laterally toward either the first or second conduits 54, 56.

While FIGS. 4 and 5 shows the divider 38 being secured between the first and second shells 22, 24 with flanges 58, 60, it should be understood that the divider 38 may be secured in place in other ways. According to an exemplary embodiment, the divider 38 may be coupled to the first shell 22 and/or the second shell 24 with a tongue-and-groove configuration. For example, the side edges 44 of the divider 38 may define a tongue or a groove configured to engage a corresponding groove or tongue defined by the first shell edge 30 and/or the second shell edge 36.

Referring to FIG. 4, the divider 38 is shown according to an exemplary embodiment. Specifically, the divider 38 includes a bearing structure 62 extending from the first side 55 of the divider 38. It should be understood that while FIG. 4 only shows the first side 55 of the divider 38, the second side 57 of the divider 38 includes substantially the same bearing structure 62 (e.g., opposing first and second bearing structures 62). The bearing structure 62 includes a divider boss 64 extending substantially perpendicular to and away from the divider 38 and defining a boss end 66 opposing the divider 38. The divider boss 64 further defines a bore 68 having a bore diameter D_{bore} and defining a bore longitudinal axis 70. The bore 68 extends away from the boss end 66 toward the first side 55 of the divider 38, but does not extend through the divider 38, such that the divider 38 limits how far an object may be inserted into the bore 68.

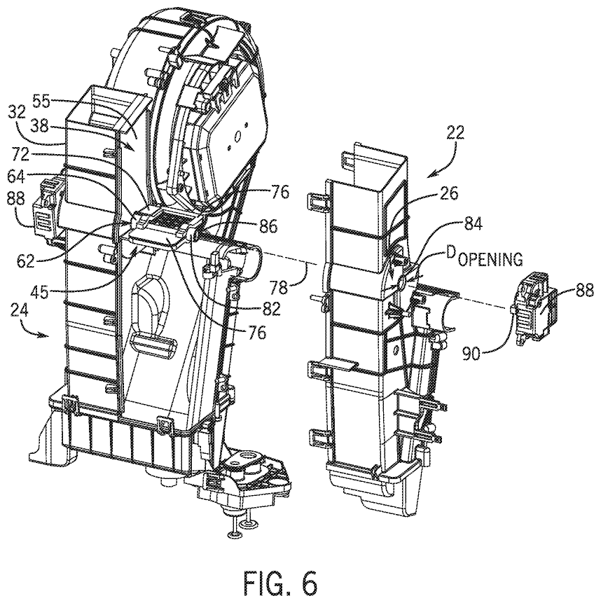

The bearing structure 62 further includes a plurality of stops 72 (i.e., fins, catches, ribs, etc.), extending substantially perpendicular to and away from the divider 38. For example, each stop 72 extends further away from the divider 38 than the boss end 66, such that the stops 72 are configured to engage the door 45 and constrain movement thereof. As shown in FIG. 4, each stop 72 extends from the divider boss 64 to one of the side edges 44 of the divider 38. The stops 72 are substantially planar and oriented parallel relative to each other, such that the door 45 is configured to engage both of the stops 72 when the door 45 is in one of the fully open or fully closed positions (e.g., as shown in FIG. 6, discussed below). When the door 45 is in the fully closed position, the door 45 may sealingly engage the stops 72 to ensure that air does not pass between the door 45 and the stops 72, thereby preventing air from flowing through the corresponding conduit 54, 56.

The bearing structure 62 is defined between the first end 40 of the divider 38 and the second end 42 of the divider 38. For example, the first end 40 of the divider 38 is upstream in the housing assembly 12 from the bearing structure 62 and the second end 42 is downstream from the bearing structure 62, such that the door 45 is configured to engage the bearing structure 62 between the first and second ends 40, 42 of the divider 38. Notably, in this configuration, a door 45 is disposed in each of the first and second conduits 54, 56, downstream from the first end 40 of the divider 38, such that each of the conduits 54, 56 may be separately controlled by their own corresponding doors 45 rather than collectively by a single door upstream from the first end 40 of the divider 38. Similarly, the doors 45 are disposed in the corresponding conduits 54, 56 upstream from the second end 42 of the divider 38, such that the doors separately articulate to control the volume flow rate of air in each conduit 54, 56.

Referring still to FIG. 4, the door 45 is shown according to an exemplary embodiment. The door 45 includes a hub 74 and two opposing flaps 76 extending from the hub 74 (e.g., coplanar, parallel, etc.). It should be understood that while the door 45 shown in FIG. 4 has two flaps 76 with the hub 74 disposed between the two flaps 76, the door 45 may include more or fewer flaps 76 and may be configured in other ways. The hub 74 defines a longitudinal door axis 78 extending therethrough. The door 45, including the hub 74 and the flaps 76, is configured to rotate as a single component about the longitudinal door axis 78 between the open and closed positions. The door 45 defines a first door boss 80 at a first end 81 of the hub 74 and the first door boss 80 defines a door boss outer diameter D_{boss}, which is substantially the same as or less than the bore diameter D_{bore}, such that the first door boss 80 is configured to be received in the bore 68 of the divider boss 64. A second door boss 82 is defined at an opposing second end 83 of the hub 74 and the first and second door bosses 80, 82 are formed annularly about the longitudinal door axis 78 for rotation about the longitudinal door axis 78.

As shown in FIG. 4, the second door boss 82 is substantially the same as the first door boss 80. For example, the second door boss 82 defines the same door boss outer diameter D_{boss} as the first door boss 80. In this configuration, either of the first door boss 80 or the second door boss 82 is configured to be received in and engage the bore 68 of the divider boss 64 for securing the door 45 in the first or second conduit 54, 56. Specifically, the door 45 is substantially symmetrical about and across the longitudinal door axis 78, such that during assembly of the housing assembly 12, an operator installing the doors 45 in the housing assembly 12 may orient the door 45 in any direction, and insert either of the first or second door bosses 80, 82 in the bore 68. A height of the divider boss 64 (e.g., distance of the boss edge 66 away from the divider 38) may be large enough, such that when the first or second door boss 80 is disposed within the bore 68, the interaction between the bore 68 and the first or second door boss 80 prevents the door 45 from moving. For example, in a configuration in which the first shell 22, the second shell 24, and the divider 38 are oriented substantially horizontally during assembly, the door longitudinal axis 78 may extend substantially vertically (e.g., relative to the ground) and the interaction between the bore 68 and the first or second door bosses 80, 82 prevent the door 45 from falling over after the door 45 engages the bearing structure 62 but before the second shell 24 is installed on the first shell 22.

Referring now to FIG. 6, the door 45 is shown installed in (e.g., coupled to) the bearing structure 62. Specifically, the first door boss 80 is disposed in the bore 68. As shown in FIG. 6, the first shell 22 defines an opening 84 (i.e., hole, shell bore, etc.) extending through the first end surface 26. The opening 84 is substantially circular and defines an opening diameter D_{opening}, which is substantially the same as or greater than the door boss outer diameter D_{boss}. The opening 84 is axially aligned with the bore 68 and the opening diameter D_{opening} is substantially the same as the door boss outer diameter D_{boss}, such that the opening 84 is also configured to receive either of the first or second door bosses 80, 82. In the configuration shown in FIG. 6, the second door boss 82 is configured to extend through at least a portion of the opening 84, thereby retaining the door 45 in place in the first conduit 54. Specifically, the first door boss 80 engages the bore 68 and the second door boss 82 engages the opening 84 and the longitudinal door axis 78 is substantially aligned with the longitudinal axis of the bore 68, such that the longitudinal door axis 78 extends axially through the bore 68 and the opening 84.

As shown in FIG. 6, the second door boss 82 defines an elongated channel 86 extending from an outer surface 88 of the second door boss 82 into the door boss 82 (e.g., along the longitudinal door axis 78). The channel 86 is elongated in a direction substantially perpendicular to the longitudinal door axis 78. An actuator 88 (i.e., a first actuator) is disposed on an outer surface of the first shell 22 (e.g., the first end surface 26) and includes a shaft 90, which is configured to be received in the channel 86. For example, the shaft 90 may be elongated in substantially the same way as the channel 86, such that the shaft 90 and the channel 86 define a keyed configuration for rotatably coupling the shaft 90 to the channel 86. It should be understood that the shaft 90 may be rotatably coupled to the channel 86 or other portions of the second door boss 82 in other ways (e.g., splines, press-fit, etc.). As the actuator 88 rotates, the shaft 90 causes the second door boss 82 and therefore the door 45 itself to rotate about the longitudinal door axis 78 between the open and closed positions.

As discussed above, the first and second door bosses 80, 82 are substantially the same. Accordingly, the first door boss 80 defines a channel 86 substantially the same as the channel 86 in the second door boss 82. In this configuration, the shaft 90 may be received in the channel 86 in the first door boss 80 when the door 45 is oriented, such that the first door boss 80 extends through the opening 84 and the second door boss 82 is disposed in the bore 68. Similarly, an actuator 88 (i.e., a second actuator) is disposed on an outer surface of the second shell 24 (e.g., the second end surface 32) and is configured to be rotatably coupled to a second door 45 disposed in the second conduit 56.

During operation of the system 10, a first door 45 is disposed in the first conduit 54 and is coupled to a first actuator 88. The first door 45 is configured to rotate between the open and closed positions. Similarly, a second door 45 is disposed in the second conduit 56 and is coupled to a second actuator 88, which is independently articulated (i.e., operated, actuated, rotated, controlled, etc.) from the first actuator 88. The open position may be defined as when the flaps 76 are oriented substantially parallel to the first or second shells 22, 24 and the closed position may be defined as when the flaps 76 are oriented substantially perpendicular to the first or second shells 22, 24. In order to provide a volume flow rate in the first conduit 54 that is different than a volume flow rate in the second conduit 56, the first door 45 may be oriented at a different angular position than the second door 45.

According to an exemplary embodiment, the system 10 may be provided in a first condition for providing air to a single zone. In this configuration, the first door 45 may be oriented in a fully open position or a position between the fully open position and the closed position (i.e., a partially-open position). The second door 45 is oriented in the closed position, such that the second door 45 seals the second conduit 56 and prevents air from flowing therethrough. In this configuration, air may only pass through the first conduit 54 in the space between the first door 45 and the first shell 22. The volume flow rate in the zone corresponding to the first conduit 54 may further be controlled by changing the position of the first door 45 and/or changing the rotational speed of the blower 14. For example, if a passenger in the first zone of the vehicle desires to increase the volume flow rate (e.g., to increase cooling in the first zone), the first door 45 is rotated away from the closed position and toward the open position, increasing the open cross-sectional area in the first conduit 54 proximate the first door 45. Similarly, if the passenger desires to decrease the volume flow rate, the first door 45 is rotated away from the open position and toward the closed position, decreasing the open cross-sectional area in the first conduit 54 proximate the first door 45. It should be noted that while this configuration includes the first conduit 54 supplying air to the vehicle and the second conduit 56 preventing air flow, according to another exemplary embodiment, the second conduit 56 may be configured to pass air therethrough, such that the first door 45 is oriented in the closed position, such that the second door 45 prevents air from passing through the second conduit 56. In this configuration, the second door 45 is oriented in an open position and may rotate between the fully open position and the closed position in substantially the same ways as the first door 45, as described above.

According to another exemplary embodiment, a first passenger in a first zone in the vehicle may desire for air to be output from the first conduit 54 to the first zone at a first volume flow rate and a second passenger in a second zone in the vehicle may desire air to be output from the second conduit 56 to the second zone at a second volume flow rate that is different than the first volume flow rate. In this configuration, neither of the first or second doors 45 is oriented in the closed (i.e., fully closed) position. Instead, the first door 45 is oriented in an fully or partially open position and the second door 45 is oriented in a fully or partially open position different from the position of the first door 45. In this configuration, when the first door 45 is rotated more toward the fully open position than the second door 45, the open cross-sectional area in the first conduit 54 proximate the first door 45 is greater than the open cross-sectional area in the second conduit 56 proximate the second door 45, such that a larger volume flow rate passes through the first conduit 54 than the second conduit 56 with the single blower 14 operating at a fixed rotational speed. The volume flow rates in the first and second conduits 54, 56 may further be adjusted by reorienting the first and second doors 45 relative to each other.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is to be understood that although the present invention has been described with regard to preferred embodiments thereof, various other embodiments and variants may occur to those skilled in the art, which are within the scope and spirit of the invention, and such other embodiments and variants are intended to be covered by corresponding claims. Those skilled in the art will readily appreciate that many modifications are possible (e.g., variations in sizes, dimensions, structures, shapes and proportions of the various elements, mounting arrangements, orientations, manufacturing processes, etc.) without materially departing from the novel teachings and advantages of the subject matter described herein. For example, the order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. An HVAC system for a vehicle comprising:
a first shell;
an opposing second shell;
a divider disposed between the first shell and the second shell;
a first conduit defined between the first shell and a first side of the divider;
a first door disposed in the first conduit and configured to control a volume flow rate in the first conduit;
a first actuator configured to articulate the first door;
a second conduit defined between the second shell and a second side of the divider opposing the first side;
a second door disposed in the second conduit and configured to control a volume flow rate in the second conduit; and
a second actuator configured to articulate the second door separately from the first door.

2. The system of claim 1, further comprising a blower disposed in the system upstream from the divider and configured to provide air to the first and second conduits at substantially the same volume flow rate.

3. The system of claim 2, wherein:
each of the first door and second door are configured to rotate between an open position and a closed position;
the first door is oriented in a different position than the second door, such that air passes through the first conduit at a higher volume flow rate than in the second conduit.

4. The system of claim 1, wherein:
the divider defines a first end and an opposing second end downstream from the first end; and
the first and second doors are downstream from the first end of the divider and upstream from the second end of the divider.

5. The system of claim 4, further comprising:
a first outlet opening defined by the first shell and a divider outlet edge at a downstream end of the first shell; and
a second outlet opening defined by the second shell and the divider outlet edge at a downstream end of the second shell.

6. The system of claim 1, further comprising:
a first plurality of flanges extending from the first shell into the first conduit and engaging the first side of the divider; and
a second plurality of flanges extending from the second shell into the second conduit and engaging a second side of the divider,
wherein the first and second plurality of flanges are configured to retain the divider therebetween.

7. The system of claim 1, further comprising a first bearing structure comprising:
a divider boss extending perpendicular to and away from the first side of the divider and defining a boss end opposing the first side of the divider; and
a bore extending from the boss end to the first side of the divider, the bore defining a bore diameter.

8. The system of claim 7, wherein:
the first shell defines a first end surface opposing the first side of the divider and an opening extending through the first end surface;
a longitudinal axis is defined by the bore of the divider boss and extends through the opening in the first end surface; and
the opening defines an opening diameter that is substantially the same as the bore diameter.

9. The system of claim 7, further comprising a plurality of stops extending substantially perpendicular to and away from the first side of the divider,
wherein the divider defines opposing side edges disposed between the first and second shells;
wherein the plurality of stops extend from the divider boss to each of the side edges of the divider; and
wherein the first door is configured to engage the plurality of stops when the first door is in a closed position.

10. The system of claim 7, wherein:
the first door comprises a hub defining a first door boss and an opposing second door boss that is substantially the same as the first door boss; and
each of the first door boss and the second door boss is configured to be received in either of the bore of the divider boss or the opening in the first end surface.

11. The system of claim 1, wherein:
the first shell defines a first end surface opposing the first side of the divider;
the second shell defines a second end surface opposing the second side of the divider;
the first actuator is disposed on the first end surface; and
the second actuator is disposed on the second end surface.

12. An HVAC system for a vehicle comprising:
a shell defining an end surface and a shell edge opposing the end surface;
a divider disposed against the shell edge;
a conduit defined between the shell and a first side of the divider;
a bearing structure comprising:
a divider boss extending perpendicular to and away from the first side of the divider and defining a boss end opposing the first side of the divider; and
a bore extending from the boss end to the first side of the divider, the bore defining a bore diameter;
a door disposed in the conduit and configured to control a volume flow rate in the conduit, the door comprising:
a hub defining a first door boss and an opposing second door boss that is substantially the same as the first door boss;
wherein the bore of the divider boss is configured to receive either of the first door boss or the second door boss.

13. The system of claim 12, wherein the first door boss is disposed in the bore of the divider boss and engages the first side of the divider therein.

14. The system of claim 12, wherein:
the bore of the divider boss defines a longitudinal axis;
the hub defines a longitudinal door axis substantially aligned with the longitudinal axis of the bore; and
the door is configured to rotate about the longitudinal door axis between open and closed positions.

15. The system of claim 14, further comprising an opening extending through the end surface,
wherein the longitudinal axis extends through the opening in the end surface; and
wherein the opening defines an opening diameter that is substantially the same as the bore diameter.

16. The system of claim 14, wherein the first door boss is disposed in the bore of the divider boss and the second door boss extends through the opening in the end surface.

17. The system of claim 12, wherein each of the first door boss and the second door boss define a channel configured to receive a shaft of an actuator therein.

18. The system of claim 12, further comprising a plurality of stops extending substantially perpendicular to and away from the first side of the divider,
wherein the divider defines opposing side edges;
wherein the plurality of stops extend from the divider boss to each of the side edges of the divider; and
wherein the door is configured to engage the plurality of stops when the door is in a closed position.

19. A method of operating an HVAC system comprising:
providing a blower;
separating air output from the blower into first and second conduits downstream from the blower;
orienting a first door in the first conduit in a first position between an open position and a closed position;
orienting a second door in the second conduit in a second position between an open position and a closed position, the second position different from the first position;
wherein the first door is configured to output air at a first volume flow rate; and
wherein the second door is configured to output air at a second volume flow rate different from the first volume flow rate.

20. The method of claim 19, further comprising orienting the second door in the closed position, wherein the first conduit receives and outputs all of the air output from the blower.
